(19) United States
(12) Patent Application Publication
(10) Pub. No.: US 2006/0221785 A1
(43) Pub. Date: Oct. 5, 2006

(54) Optical disk apparatus and an optical disk playback method

(76) Inventor: Yuichiro Yamamoto, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/389,064

(22) Filed: Mar. 27, 2006

(30) Foreign Application Priority Data
Mar. 31, 2005 (JP) 2005-103605

(51) Int. Cl. G11B 7/00

(52) U.S. Cl. 369/44.41

(57) ABSTRACT

An optical disk apparatus adopted to play back an optical disk, includes a laser source to emit a laser beam to an optical disk, a condenser lens to condense the laser beam reflected by the optical disk, a photodetector irradiated by the condensed laser beam and including a main light receiving part and an auxiliary light receiving part disposed adjacently to the main light receiving part, and a signal processor to output a difference between an output of the main light receiving part and an output of the auxiliary light receiving part as a playback signal representing information recorded on an information recording layer of the optical disk.

### CROSS-REFERENCE TO RELATED APPLICATIONS

This application is based upon and claims the benefit of priority from prior Japanese Patent Application No. 2005-103605, filed on Mar. 31, 2005, the entire contents of which are incorporated herein by reference.

### BACKGROUND OF THE INVENTION

1. Field of the Invention

The present invention relates to an optical disk apparatus for playing back information using a laser beam, more particularly relates to an optical disk apparatus to reduce DC offset occurring due to light reflected by a layer to be not played back and leaking to a photodetector when an optical disk having a double-layer information recording layer is played back.

2. Description of the Related Art

The next-generation high-density optical disks having record capacity of three or four times of that of the currently distributed DVD (Digital Versatile Disc) have been developed. Optical disks (referred to as HD DVD hereinafter) optimized to a substrate thickness of 0.6 mm and used for a wavelength 400 nm band blue-violet semiconductor laser and an objective lens of a numerical aperture 0.65 have been developed in terms of compatibility with existing CD (Compact Disc) and DVD, facility of manufacturing of a small-size optical head apparatus for a slim line book-size personal computer, lower disk manufacturing cost. In this HD DVD, a double layer disk have been developed in order to increase an amount of recording information similarly to DVD.

However, the double layer disk has a problem that DC offset occurs on a servo signal and a playback signal due to interlayer crosstalk. In other words, when one of information recording layers is played back, an undesired light reflected by the other information recording layer (referred to as a non-playback layer hereinafter) leaks to a photodetector. The playback signal of the undesired light is combined with a servo signal and a playback signal, resulting in DC offset.

As thus described, the DC offset occurring on the playback signal appears notably in the double layer optical disk of rewritable type. In particular, in the case that data is written intensively at a part of the non-playback layer, when the light beam passes through the data region (recording region) of the non-playback layer during playback of the playback layer, the reflectivity of the disk varies greatly, resulting in causing DC offset on the playback signal. This becomes a problem causing characteristic deterioration of the playback signal.

An offset reduction method described in Japanese Patent Laid-Open No. 9-161282 is effective for reducing DC offset of a focusing error signal occurring due to interlayer crosstalk. In an example of an optical record/playback apparatus mentioned in Japanese Patent Laid-Open No. 9-161282, there is provided an auxiliary light receiving region for detecting light run over a main light receiving region when a light beam is largely defocused. A playback signal is generated as a sum signal of output signals from all light receiving regions. The light run over the main light receiving region in defocusing is detected by the auxiliary light receiving region, and the detected signal is subtracted from the sum signal. This allows for making the falling edge of a focusing error signal to be precipitous when the light beam defocuses significantly. Therefore, the focusing error signal on the double-layer disk is difficult to be influenced by the other layer, so that DC offset in the focused position is reduced.

By the way, in the double-layer DVD, the thickness of the two layers is defined to 55 μm±15 μm for the wavefront aberration of the beam spot on the information recording layer to be kept not more than tolerance. When the similar reference is applied to HD DVD, the thickness of the double-layer becomes as small as about 25 μm. This is because the wavefront aberration occurring due to the thickness deviation of the substrate is almost proportional to four power of the objective lens numerical aperture and inversely proportional to the laser wavelength.

As above described, the thickness of the double-layer becomes small in HD DVD, so that influence of interlayer crosstalk becomes remarkable in comparison with DVD. Therefore, the system design interweaving an anti-interlayer crosstalk measure is required for HD DVD than DVD.

As mentioned above, the thickness of the double layer in HD DVD is small in comparison with DVD, and thus this influences a servo signal for interlayer crosstalk and a playback signal remarkably. The DC offset occurring due to the focusing error signal can be reduced by a method described in Japanese Patent Laid-Open No. 9-161282. However, it is necessary to take a reduction countermeasure against DC offset occurring on a playback signal in playing back the double-layer disk.

The object of the present invention is to provide an optical disk apparatus having good playback signal characteristics by reducing DC offset of a playback signal occurring due to interlayer crosstalk in playing back the double-layer disk.

### BRIEF SUMMARY OF THE INVENTION

An aspect of the present invention provides an optical disk apparatus adopted to play back an optical disk, comprising a laser source to emit a laser beam to an optical disk; a condenser lens to condense the laser beam reflected by the optical disk, a photodetector irradiated by the condensed laser beam and including a main light receiving part and an auxiliary light receiving part disposed adjacently to the main light receiving part, and a signal processor to output a difference between an output of the main light receiving part and an output of the auxiliary light receiving part as a playback signal representing information recorded on an information recording layer of the optical disk.

### BRIEF DESCRIPTION OF THE SEVERAL VIEWS OF THE DRAWING

FIG. 1 is a diagram of an optical system of a first embodiment.

FIGS. 2A and 2B are diagrams showing beam profiles of light reflected by a playback layer and a non-playback layer and landing on the photodetector.

FIG. 3 shows a block diagram for explaining playback signal calculation.

FIG. 4 is a block circuit for playback signal calculation and focusing error signal calculation according to the first embodiment.

FIG. 5 is a diagram of an optical system according to a second embodiment.

FIG. 6 is a diagram of a 6-division diffraction element and a 12-division photodetector according to the second embodiment.

FIGS. 7A, 7B and 7C show beam profiles on the photodetector when the disk is far from a focusing position, at the focusing position, and near than the focusing position.

FIG. 8 is a block circuit for playback signal calculation and focusing error signal calculation according to the second embodiment.

FIGS. 9A and 9B show beam profiles of light reflected by a playback layer and a non-playback layer and landing on the photodetector.

FIG. 10 is a diagram of an optical system according to a third embodiment.

FIG. 11 is a diagram of a division type diffraction element driven integrally with an objective lens.

FIG. 12 shows a block circuit for playback signal calculation and focusing error signal calculation according to the third embodiment.

FIGS. 13A and 13B show beam profiles on a photodetector surface in defocusing.

### DETAILED DESCRIPTION OF THE INVENTION

Embodiments of the present invention are explained in conjunction with the drawing in detail hereinafter.

### First Embodiment

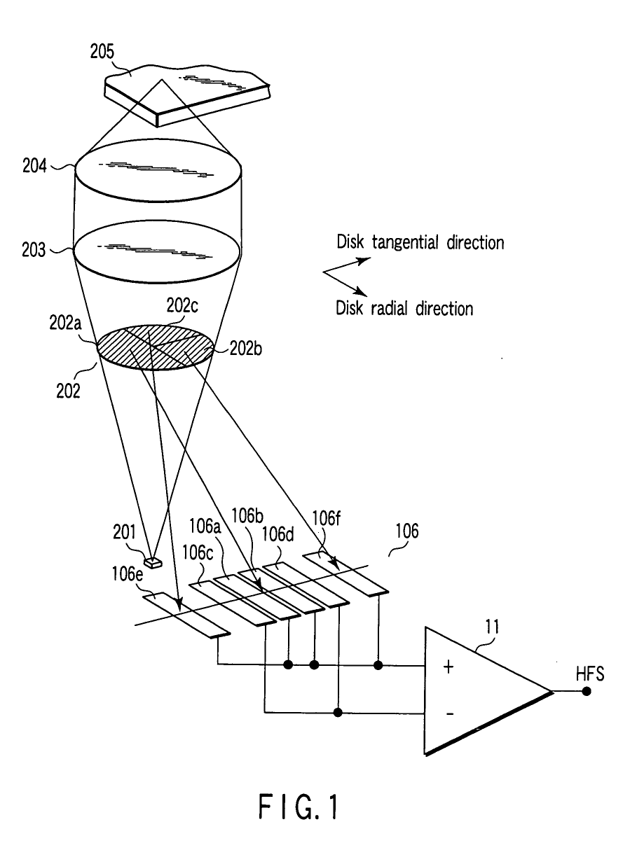

An optical system and a playback signal output system of the first embodiment are shown in FIG. 1. The laser beam emitted from a semiconductor laser 201 is diffracted with a diffracting device 202. The 0th light of the laser beam from a diffracting device 202 is converted into a parallel light beam with a collimating lens 203 and focused on an information recording layer of an optical disk 205 with an objective lens 204. The light reflected by the information recording layer progresses in a reverse direction with respect to an outward path and converted into a parallel light beam with the objective lens 204. The parallel light beam is converted into a convergence light beam with the collimating lens 203 and incident on the diffracting device 202. The diffracting device 202 is divided into three division regions 202a to 202c. The region 202a and the regions 202b and 202c are divided by a division line in a disk radial direction indicating a radial direction of the optical disk. The regions 202b and 202c are divided by a division line in a disk tangential direction indicating a tangential direction of the optical disk 205.

A photodetector 106 having light receiving regions 106a to 106f is disposed in association with the diffracting device 202 so that the light diffracted by the region 202a of the diffracting device 202 is led to the light receiving regions 106a and 106b of the photodetector 106 and the light diffracted with the regions 202b and 202c are led to the light receiving regions 106f and 106e of the photodetector 106, between which an array of the regions 106a to 106d are arranged. The signals output from the light receiving regions 106a and 106b by the light beam diffracted by the region 202a are used for obtaining a focusing error signal by a single knife edge method. Based on this focusing error signal, an objective lens actuator (not shown) positions the objective lens 204 in an optical axis direction.

The signals output from the light receiving regions 106e and 106f by the light beams diffracted with the regions 202b and 202c are used for obtaining a tracking signal by a push-pull method or a DPD (Differential Phase Detection) method. Based on this (tracking error signal, a tracking device (not shown) positions the objective lens 204 in the disk radial direction.

The light receiving regions 106a to 106f of the photodetector 106 shown in FIG. 1 generate output signals Sa, Sb, Sc, Sd, Se and Sf corresponding to incident light beams, respectively. The signals Sa, Sb, Se and Sf are supplied to a noninverting input terminal of an operational amplifier 11 serving as a signal processor, and the signals Sc and Sd are input to an inverting input terminal thereof. As a result, a playback signal (HFS) is played back according to the following equation (1):
HFS=Sa+Sb+Se+Sf−(Sc+Sd) (1)

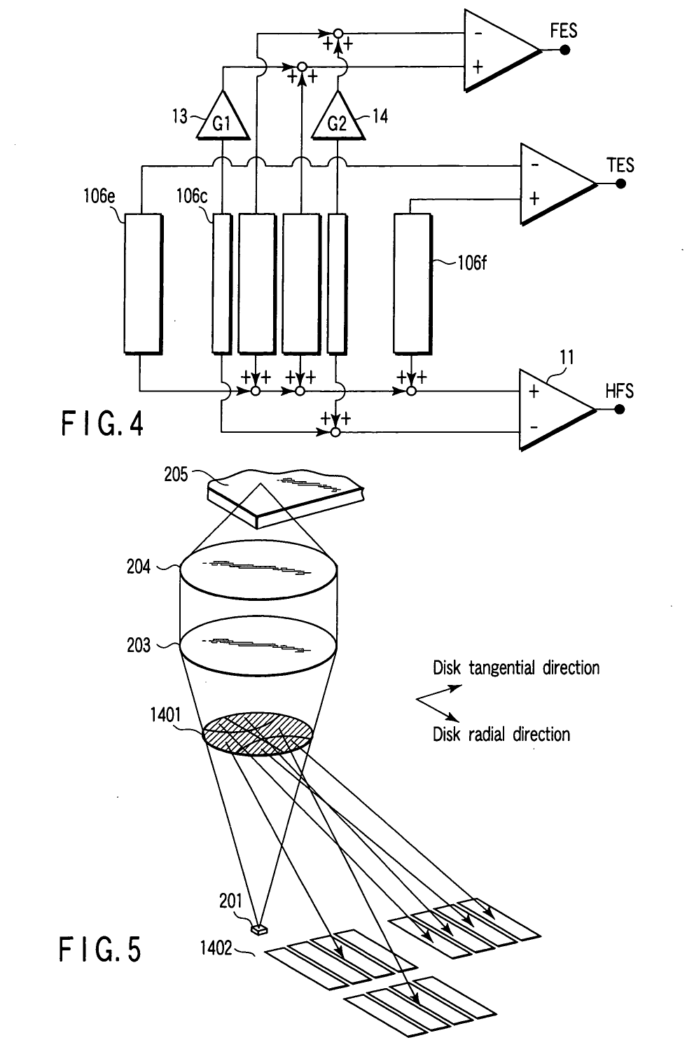

This playback signal is a signal indicating information recorded on the optical disk 205. The auxiliary light receiving regions 106c and 106d are provided for reducing DC offset of the focusing error signal occurring due to interlayer crosstalk. The playback signal is generated by subtracting a sum signal of signals Sc and Sd from these auxiliary light receiving regions 106c and 106d from a sum signal from the other light receiving regions 106a, 106b, 106e and 106f with the operational amplifier (signal processor) 11. The method of generating a focusing error signal by a single knife edge method and the method of generating a tracking error signal by a push-pull method or DPD method are executed by the block circuit of FIG. 4 according to the following equations (2), (3) and (4).
FES (single knife edge method)=Sb+G1*Sc−(Sa+G2−Sd) (2)
TES (push-pull method)=Sf−Se (3)
TES (DPD method)=phase (Sf)−phase (Se) (4)

In FIG. 4, an amplifier 13 corresponds to G1 of the equation (2) and amplifies the signal Sc with an amplification factor G1. An amplifier 14 corresponds to G2 of the equation (2) and amplifies the signal Sc with an amplification factor G2. The method of generating a tracking error signal uses a push-pull method if the optical disk is DVD-RAM, for example, and a DPD method if it is DVD-ROM.

The light receiving regions 106a to 106f are light receiving regions necessary for generating the focusing error signal and tracking error signal. A light receiving region for reducing DC offset occurring on the playback signal needs not to be provided newly, so that the configuration is extremely simplified.

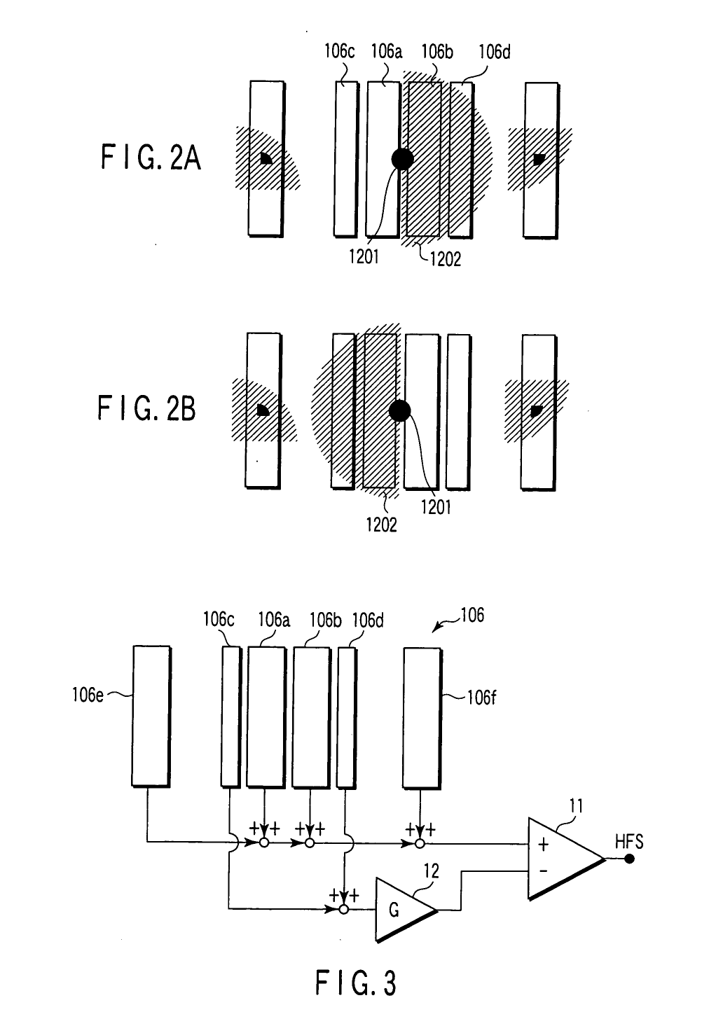

Effect of the above calculation method will be explained. FIG. 2A shows a beam profile of the light reflected by the playback layer and landing on a photodetector surface, and a beam profile of undesired light reflected by the 1st information recording layer (non-playback layer) and landing on the photodetector surface, when the light beam is focused on the 0-th information recording layer (playback layer). FIG. 2B shows a beam profile when the light beam is focused on the 1st information recording layer. In either case, it is found that an undesired light from the non-playback layer extends over the main light receiving region 106a and 106b and the auxiliary light receiving region 106c and 106d. If the playback signal is generated by calculating a difference between the sum of the signals of the main light receiving regions 106a and 106b and the sum of the signals of the auxiliary light receiving regions 106c and 106d according to the equation (1), it is found that influence of undesired leakage light can be reduced.

When a monolayer disk is played back, light does not leak to the auxiliary light receiving regions 106c and 106d. Therefore, the output signals from the auxiliary light receiving regions 106c and 106d are zero. In this case, the playback signal may be generated by the equation (1).

As described above, according to the method of the present invention, DC offset occurring on the focusing error signal and playback signal in the double-layer disk can be reduced effectively.

As a playback signal output unit shown in FIG. 3, it is preferable that an amplifier 12 is provided after the photodetector 106 to improve an effect of reducing the interlayer crosstalk by adjusting a level of the signal. The method of calculating a playback signal (HFS) in this case is executed according to the following equation (5):
HFS=Sa+Sb+Se+Sf−G(Sc+Sd) (5)

where G represents a given gain of the amplifier 12.

### Second Embodiment

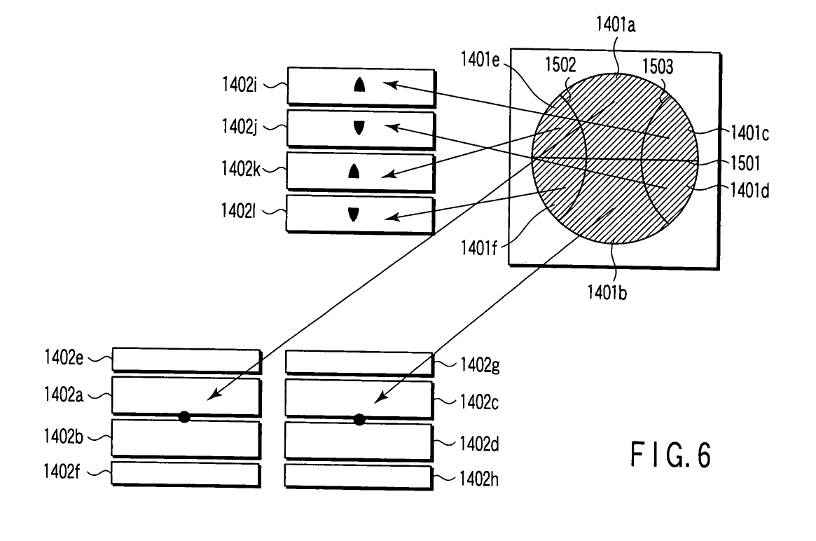

The first embodiment uses a single knife edge method as a method of detecting a focusing error. However, the present invention is not limited to this method. FIG. 5 shows an optical system according to the second embodiment, which uses a double knife edge method as the method of detecting a focusing error. The second embodiment differs from the first embodiment in a division configuration of a diffracting device and a light receiving surface configuration of a photodetector. As shown in FIG. 5, a diffracting device 1401 is divided into six division regions, and the light receiving surface of the photodetector 1402 is divided into twelve division regions. The diffracting device 1401 and photodetector 1402 are shown in FIG. 6 in detail.

The diffracting device 1401 is divided into six regions 1401a to 1401f by a dividing line 1501 in a disk radial direction and division curves 1502 and 1503 reflecting±1st light diffracted from a land/groove disk as shown in FIG. 6. The photodetector 1402 has main light receiving regions 1402a to 1402d for focusing error detection, auxiliary light receiving regions 1402e to 1402h, and light receiving regions 1402i to 14021 for tracking error detection.

Two light beams diffracted by the regions 1401a and 1401b of the diffracting device are led to the light receiving regions 1402a to 1402h, and used for generating a focusing error signal by a double knife edge method. Four light beams diffracted by the regions 1401c to 1401f of the diffracting device are led to the light receiving regions 1402i to 14021, and used for generating a focusing error signal by a push-pull method or a DPD method. The output signals from all light receiving regions are used for producing a playback signal.

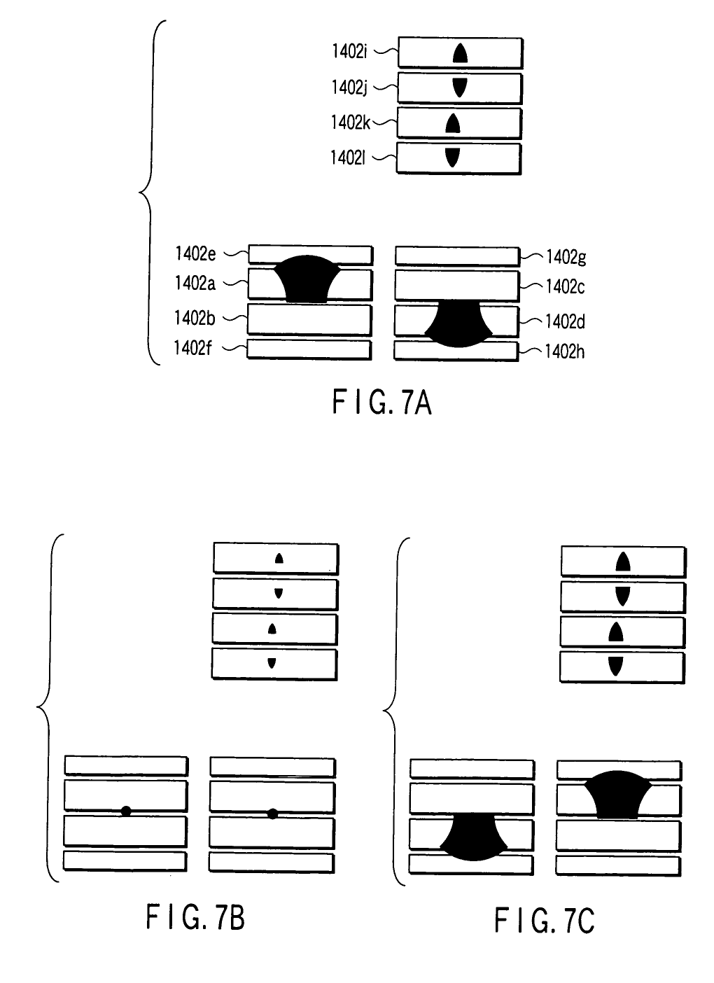

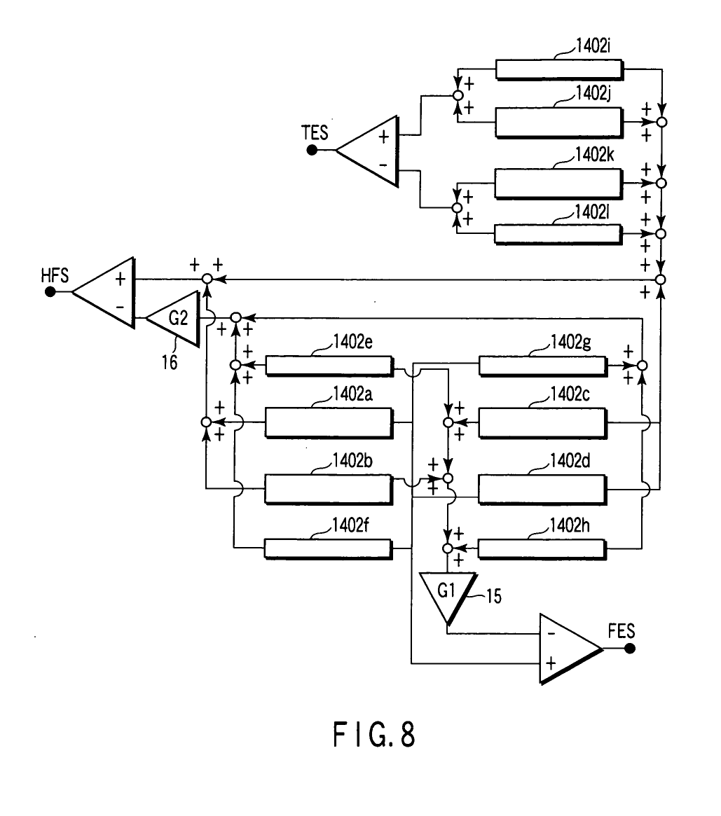

FIGS. 7A, 7B and 7C show patterns of light beams (signal light beams) from the playback layer in defocusing. FIGS. 7A, 7B and 7C show beam profiles on the photodetector when the disk is far from a focusing position, at the focusing position, and near than the focusing position. Assuming that the output signals from the light receiving regions 1402a to 14021 are Sa to Sl respectively, the focusing error signal (FES) is generated by a block circuit shown in FIG. 8, for example, according to the following equation (6):
FES (double knife edge method)=Sa+Sd+Sf+Sg−G1*(Sb+Sc+Se+Sh) (6)

where G1 represents a given gain of the amplifier 15.

The tracking error signal (TES) based on the push-pull method or DPD method is generated according to the following equations (7) and (8), respectively.
TES (push-pull method)=Si+Sj−(Sk+Sl) (7)
TES (DPD method)=phase(Si+Sk)−phase(Sj+Sl) (8)

The method of playing back the playback signal (HFS) is executed according to the following equation (9).
HFS=Sa+Sb+Sc+Sd+Si+Sj+Sk+Sl−G2*(Se+Sf+Sg+Sh) (9)

where G2 represents a given gain of the amplifier 16.

Like the first embodiment, a playback signal generating method of the present invention directed to reduction of interlayer crosstalk uses only light receiving regions for generating the focusing error signal and tracking error signal and needs not to provide newly a light receiving surface to make it possible to be executed in simple configuration.

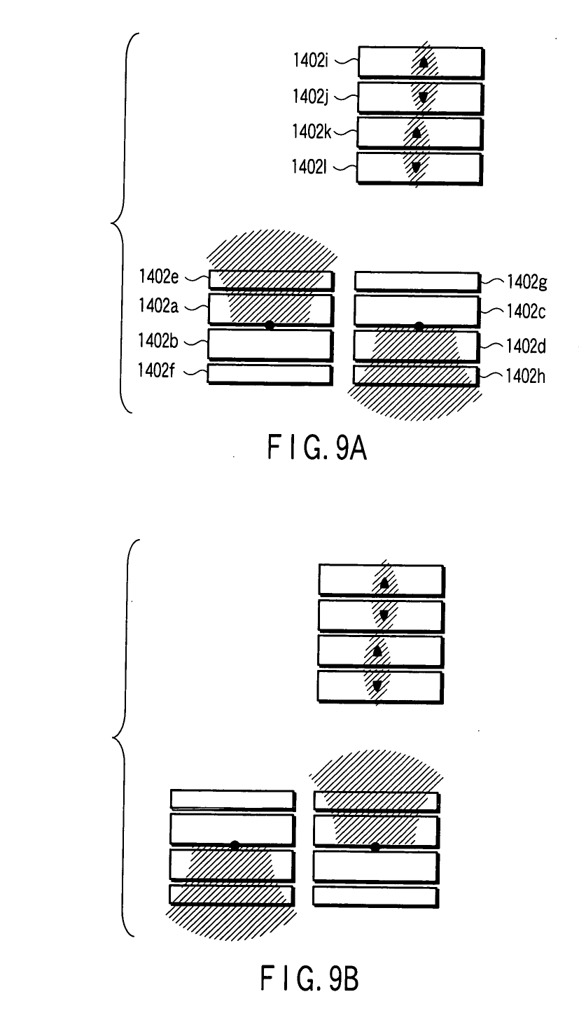

The beam patterns of undesired leakage light incident on the photodetector from a non-playback layer are shown in FIGS. 9A and 9B to explain effect of the playback signal generating method. FIG. 9A shows a beam profile of light reflected by the playback layer and landing on the photodetector surface, and a beam profile of the undesired light reflected by the first information recording layer (the non-playback layer) and landing on the photodetector surface, when the light beam focuses on the information recording layer (the playback layer).

FIG. 9B shows a beam profile on the photodetector surface when the light beam is focused on the first information recording layer. In either case, it is found that undesired light reflected by the non-playback layer expands over the main light receiving regions 1402a to 1402d and auxiliary light receiving regions 1402e and 1402h. Accordingly, if the playback signal is generated by calculating differences between the signals of the main light receiving regions 1402a to 1402d and the signals of the auxiliary light receiving regions 1402e and 1402h as indicated by the equation (9), it is found that influence of undesired leakage light can be reduced. When a monolayer disk is played back, light is leaked to the auxiliary light receiving regions 1402e to 1402h to output no signal therefrom. Therefore, there is no problem at all in playing back the monolayer disk.

### Third Embodiment

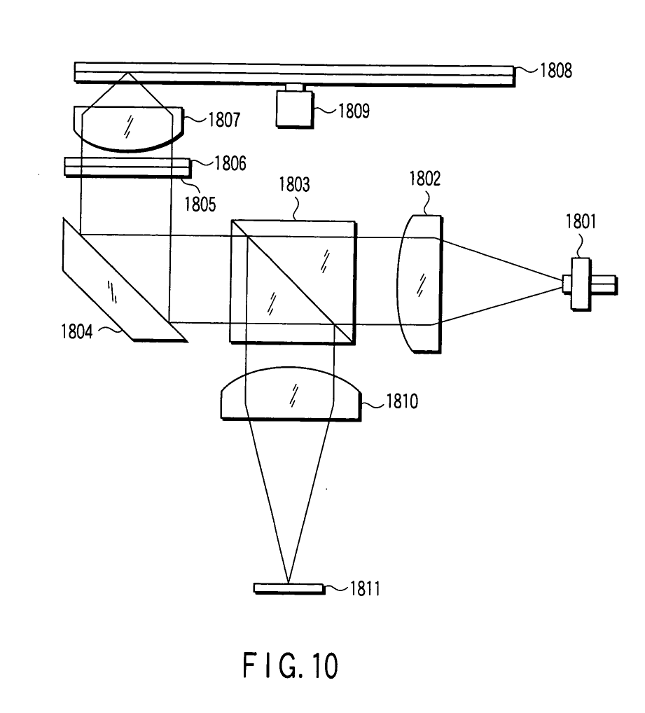

An optical system of the third embodiment of the present invention is shown in FIG. 10. This embodiment differs from the first and second embodiments with respect to a configuration that a diffracting device 1805 for generating a servo signal/playback signal and a quarter-wavelength plate 1806 are driven integrally with an objective lens 1807. The linearly polarized laser beam emitted from the semiconductor laser 1801 is converted into a parallel light beam with a collimator lens 1802, transmitted through a polarization beam splitter 1803, and reflected by an up-rise mirror 1804. Subsequently, the laser beam is incident on the diffracting device 1806 and the quarterwave plate 1805 driving integrally with the objective lens 1807.

The laser beam is converted from a linearly polarized light beam to a circularly-polarized light beam with the quarterwave plate 1805 and focused on the information recording layer of the optical disk 1808 with the objective lens 1807. The laser beam reflected by the information recording layer follows a path opposite to the outward path and is converted into a parallel light beam with the objective lens 1807. The parallel light beam is diffracted by the division type diffracting device 1806. The diffracted light beam is converted from the circularly-polarized light beam into the linearly-polarized light beam perpendicular to that in the outward path with the quarterwave plate 1805, and reflected by the polarization beam splitter 1803. The reflected light beam is conversed with the condenser lens 1810 and incident on the photodetector 1811 for generating a servo signal/playback signal.

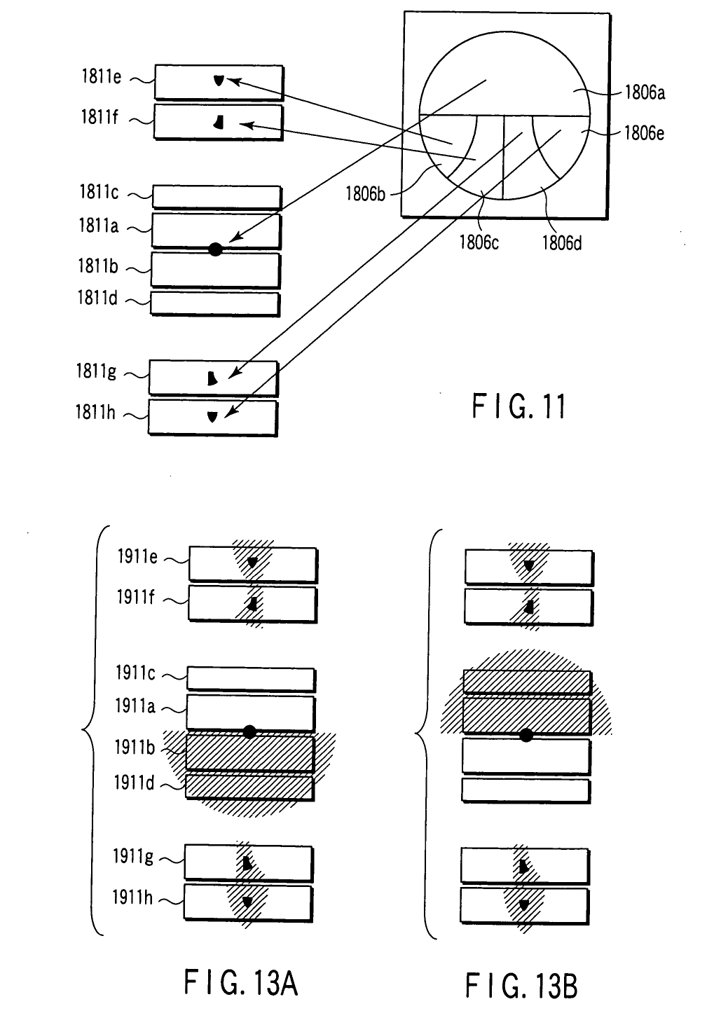

The division shape of the division type diffracting device may be similar to that of the first and second embodiments. In the third embodiment, a five-division type diffracting device shown in FIG. 11 is used. The light beam diffracted by a diffracting device region 1806a is led to light receiving regions 1811a to 1811d to be used for producing a focusing error signal by a single knife edge method. The light beams diffracted with the diffracting device region 1806b to 1806e are led to light receiving regions 1811e to 1811h respectively, to be used for generating a tracking error signal by a compensation push-pull method or a DPD method.

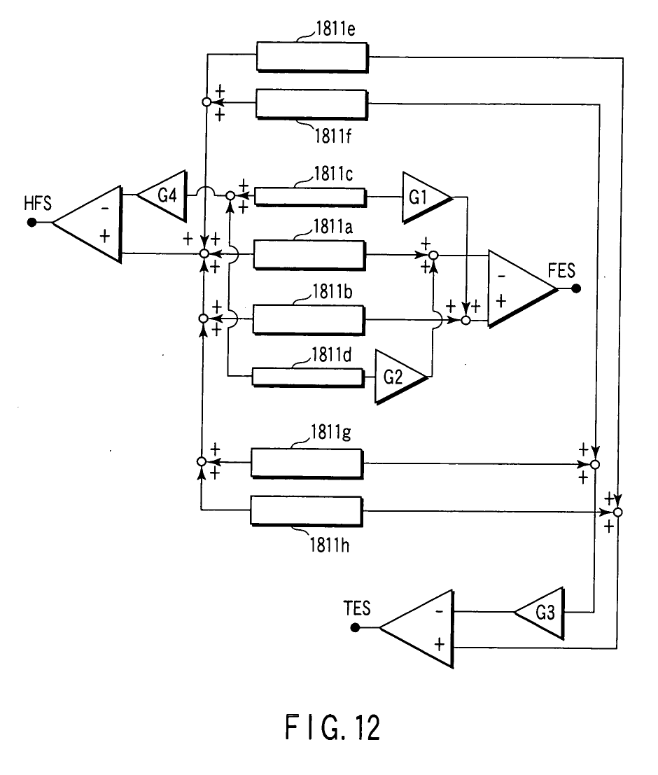

Assuming that output signals from the light receiving regions 1811a to 1811h are Sa, Sb, Sc, Sd, Se, Sf, Sg, Sh respectively, a focusing error signal based on the single knife edge method (FES), a tracking error signal based on the compensation push-pull method or DPD method (TES), and a playback signal (HFS) are produced according to the following equations (10), (11) and (12) by a block circuit shown in FIG. 12. The compensation push-pull method is a method for reducing offset of the tracking error signal caused by radial shifting of the objective lens. The detail principle of this method is described by Toshiba review Vol. 57 No. 7 p 32-p 34 (2002), the entire contents of which are incorporated herein by reference.
FES (a knife edge method)=Sb+G1*Sc−(Sa+G2*Sd) (10)
TES (compensation push-pull method)=Se−Sh−G3*(Sf−Sg) (11)
TES (DPD method)=phase(Se+Sf)−phase(Sg+Sh) (12)
HFS (a playback signal)=Sa+Sb+Se+Sf+Sg+Sh−G4*(Sc+Sd) (13)

FIG. 13A shows a beam profile of light reflected by the playback layer and landing on the photodetector surface and a beam profile of the undesired light reflected by the first information recording layer (the non-playback layer) and landing on the photodetector surface, when the light beam focuses on the information recording layer (the playback layer). FIG. 13B shows a beam profile on the photodetector surface when the light beam is focused on the first information recording layer.

Since the undesired light from the non-playback layer expands over the main light receiving regions 1811a to 1811b and auxiliary light receiving regions 1811e, 1811h, the DC offset due to interlayer crosstalk can be reduced by generating a playback signal according to the equation (13), similarly to the first and second embodiments. As a result, when playing back a double-layer disk, an optical disk apparatus having good playback signal quality can be realized.

According to the present invention, an optical disk apparatus of high reliability reducing DC offset occurring on a playback signal due to interlayer crosstalk, and having good playback signal quality can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk apparatus adopted to play back an optical disk, the apparatus comprising:
a laser source to emit a laser beam to an optical disk;
a condenser lens to condense the laser beam reflected by the optical disk;
a photodetector irradiated by the condensed laser beam and including a main light receiving part and an auxiliary light receiving part disposed adjacently to the main light receiving part; and
a signal processor to output a difference between an output of the main light receiving part and an output of the auxiliary light receiving part as a is playback signal representing information recorded on an information recording layer of the optical disk.

2. The apparatus according to claim 1, wherein the main light receiving part includes a first main light receiving region and a second light receiving region and the auxiliary light receiving part includes a first auxiliary light receiving region and a second auxiliary light receiving region between which the first main light receiving region and the second light receiving region are arranged.

3. The apparatus according to claim 2, wherein the signal processor generates a focusing error signal using signals from the first main light receiving region and the second main light receiving region, and a signal for DC offset reduction from the first auxiliary light receiving region and the second auxiliary light receiving region.

4. The apparatus according to claim 2, wherein the signal processor comprises an operational amplifier to generate the playback signal by subtracting a sum signal of output signals of the auxiliary light receiving regions from a sum signal of output signals of the main light receiving regions.

5. The apparatus according to claim 2, wherein the main light receiving part includes a third main light receiving region and a fourth main light receiving regions, which are arranged on both sides of an array of the first main light receiving region, the second light receiving region, the first auxiliary light receiving region and the second auxiliary light receiving region, for generating a tracking signal.

6. The apparatus according to claim 5, which further comprises a diffracting device to diffract the reflected light beam into three light beams directed to a set of the first main light receiving region and the second light receiving region, the third main light receiving region, and the fourth main light receiving regions, respectively.

7. An optical disk apparatus adopted to play back an optical disk, comprising:
a laser source to emit a laser beam on an optical disk;
a condenser lens to condense a laser beam reflected by the optical disk;
a photodetector including a first main light receiving part and a second main light receiving part, which are disposed adjacently to each other and irradiated by the condensed laser beam, a first auxiliary light receiving part disposed on a first side of the first main light receiving part, which is opposite to a second side thereof adjacent to the second main light receiving part, and a second auxiliary light receiving part disposed on a first side of the second main light receiving part, which is opposite to a second side thereof adjacent to the first main light receiving part; and
a signal processor to generate a playback signal from a difference between a sum of an output of the first main light receiving part and an output of the second main light receiving part and a sum of an output of the first auxiliary light receiving part and an output of the second auxiliary light receiving part, and a focusing error signal from a difference between a sum of the output of the first main light receiving part and an output of the second auxiliary light receiving part and a sum of the second main light receiving part and an output of the second auxiliary light receiving part.

8. The optical disk apparatus according to claim 7, wherein the signal processor comprises an amplifier to amplify a sum of the output of the first auxiliary light receiving part and the output of the second auxiliary light receiving part, and an operational amplifier to generate the playback signal by subtracting an output of the amplifier from the sum of the output of the first main light receiving part and the output of the second main light receiving part.

9. The apparatus according to claim 7, further comprising a third main light receiving part and a fourth main light receiving part, which are arranged on both sides of an array of the first main light receiving region, the second light receiving region, the first auxiliary light receiving region and the second auxiliary light receiving region, for generating a tracking signal.

10. The apparatus according to claim 7, which further comprises a diffracting device to diffract the reflected light beam into three light beams led to a set of the first main light receiving region and the second light receiving region, the third main light receiving region, and the fourth main light receiving regions, respectively.

11. An optical disk apparatus adopted to play back an optical disk, comprising:
a laser source to emit a laser beam to an optical disk;
a condenser lens to condense the laser beam reflected by the optical disk;
a photodetector including:
a first main light receiving part and a second main light receiving part, which are disposed adjacently to each other and irradiated by the condensed laser beam,
a first auxiliary light receiving part disposed on a first side of the first main light receiving part, which is opposite to a second side thereof adjacent to the second main light receiving part,
a second auxiliary light receiving part disposed on a first side of the second main light receiving part, which is opposite to a second side thereof adjacent to the first main light receiving part,
a third main light receiving part and a fourth main light receiving part, which are disposed adjacently to each other and irradiated by the condensed laser beam,
a third auxiliary light receiving part disposed on a first side of the third main light receiving part, which is opposite to a second side thereof adjacent to the fourth main light receiving part, and
a fourth auxiliary light receiving part disposed on a first side of the fourth main light receiving part, which is opposite to a second side thereof adjacent to the third main light receiving part; and
a signal processor to generate a playback signal from a difference between a sum of an output of the first main light receiving part, an output of the second main light receiving part, an output of the third main light receiving part and an output of the fourth main light receiving part and a sum of an output of the first auxiliary light receiving part, an output of the second auxiliary light receiving part, an output of the third auxiliary light receiving part and an output of the fourth auxiliary light receiving part, and to generate a focusing error signal from a difference between a sum of the output of the first main light receiving part, the output of the second auxiliary light receiving part, the output of the third main light receiving part and the output of the fourth auxiliary light receiving part and a sum of the output of the first auxiliary light receiving part, the output of the second main light receiving part, the output of the third auxiliary light receiving part and the output of the fourth main light receiving part.

12. The optical disk apparatus according to claim 11, further comprising an objective lens to focus the laser beam emitted by the laser source on the optical disk, and a diffracting device to diffract the laser beam reflected by the optical disk into each of the first to fourth main light receiving parts and the first to fourth auxiliary receive parts, and an actuator to actuate the objective lens and the diffracting device integrally.

13. The optical disk apparatus according to claim 11, which further comprises a diffracting device to diffract the laser beam reflected by the optical disk into each of the first to fourth main light receiving parts and the first to fourth auxiliary receive parts, and a tracking light receiving part for tracking, and wherein the diffracting device includes two division parts divided by a dividing line in a disk radial direction and four division parts divided by a dividing curve reflecting 1st light diffracted from a land/groove disk, when two light beams diffracted by two parts of the diffracting device are led to the main light receiving part and the auxiliary light receiving part, the signal processor generates the focusing error signal according to following equation:
double knife edge method=Sa+Sd+Sf+Sg−G1*(Sb+Sc+Se+Sh)
where Sa, Sb, Sc, Sd represent the outputs of the main light receiving parts, Se, Sf, Sg, Sh represent the outputs of the auxiliary light receiving part, and G1 represents a gain, and
when four light beams diffracted by four parts of the diffracting device are led to the tracking light receiving part, the signal processor generates a tracking error signal according to following equation:
push-pull method=Si+Sj−(Sk+Sl)
where Sf and Se represent outputs of the third and fourth main light receiving parts.

14. An optical disk playback method of playing back an optical disk, comprising:
preparing a photodetector having a main light receiveing part and an auxiliary light receiving part disposed adjacently to the main light receiving part;
emitting a laser beam to an optical disk;
condensing the laser beam reflected by the optical disk with a condenser lens;
emitting the reflected laser beam condensed by the condenser lens to the photodetector; and
outputting a difference between an output of the main light receiving part and an output of the auxiliary light receiving part, which are produced by emitting the reflected laser beam to the photodetector, as a playback signal representing information recorded on an information recording layer of the optical disk.

15. An optical disk playback method of playing back an optical disk, the method comprising:
preparing a photodetector having a first main light receiving part and a second main light receiving part, which are disposed adjacently to each other, a first auxiliary light receiving part disposed on a first side of the first main light receiving part, which is opposite to a second side thereof adjacent to the second main light receiving part, and a second auxiliary light receiving part disposed on a first side of the second main light receiving part, which is opposite to a second side thereof adjacent to the first main light receiving part;
emitting a laser beam to an optical disk,
condensing the laser beam reflected by the optical disk,
emitting the condensed reflected laser beam to the first main light receiving part, the second main light receiving part, the first auxiliary light receiving part and the second auxiliary light receiving part;
generating a playback signal from a difference between a sum of an output of the first main light receiving part and an output of the second main light receiving part and a sum of an output of the first auxiliary light receiving part and an output of the second auxiliary light receiving part; and
generating a focusing error signal from a difference between a sum of the output of the first main light receiving part and the output of the second auxiliary light receiving part and a sum of the output of the second main light receiving part and the output of the second auxiliary light receiving part.

16. The method according to claim 15, wherein generating the focusing error signal includes generating the focusing error signal according to following equation:
single knife edge method=Sb+G1*Sc−(Sa+G2*Sd)
where Sa, Sb represent the outputs of the first and second main light receiving parts, Sc, Sd represent the outputs of the first and second auxiliary light receiving parts, and G1, G2 represents gain, and
generating the tracking error signal includes generating the tracking error signal according to following equation:
push-pull method=Sf−Se
where Sf and Se represent the outputs of the third and fourth main light receiving parts.

17. An optical disk playback method of playing back an optical disk, comprising:
preparing a photodetector having a first main light receiving part and a second main light receiving part which are disposed adjacently to each other, a first auxiliary light receiving part disposed on a first side of the first main light receiving part, which is opposite to a second side thereof adjacent to the second main light receiving part, a second auxiliary light receiving part disposed on a first side of the second main light receiving part, which is opposite to a second side thereof adjacent to the first main light receiving part, a third main light receiving part and a fourth main light receiving part which are disposed adjacently to each other and irradiated by the condensed laser beam, a third auxiliary light receiving part disposed on a first side of the third main light receiving part, which is opposite to a second side thereof adjacent to the fourth main light receiving part, and a fourth auxiliary light receiving part disposed on a first side of the fourth main light receiving part, which is opposite to a second side thereof adjacent to the third main light receiving part;
emitting a laser beam to an optical disk;
condensing the laser beam reflected by the optical disk;
emitting the condensed reflected laser beam to the first main light receiving part, the second main light receiving part, the first auxiliary light receiving part, the second auxiliary light receiving part, the third main light receiving part, the fourth main light receiving part, the third auxiliary light receiving part, and the fourth auxiliary light receiving part;
generating a playback signal from a difference between a sum of outputs of the first main light receiving part, the second main light receiving part, the third main light receiving part and the fourth main light receiving part, and a sum of outputs of the first auxiliary light receiving part, the second auxiliary light receiving part, the third auxiliary light receiving part and the fourth auxiliary light receiving part; and
generating a focusing error signal from a difference between a sum of outputs of the first main light receiving part, the second auxiliary light receiving part, the third main light receiving part and the fourth auxiliary light receiving part and a sum of outputs of the first auxiliary light receiving part, the second main light receiving part, the third auxiliary light receiving part and the fourth main light receiving part.

18. The optical disk apparatus according to claim 17, which further comprises a diffracting device to diffract the laser beam reflected by the optical disk into each of the first to fourth main light receiving parts and the first to fourth auxiliary receive parts, and a light receiving part for tracking, and wherein
the diffracting device includes two division parts divided by a dividing line in a disk radial direction and four division parts divided by a dividing curve reflecting±primary light based on a land/groove of the disk,
when two light beams diffracted by two parts of the diffracting device is led to the main light receiving part and the auxiliary light receiving part, the signal processor generates the focusing error signal according to following equation:
double knife edge method=Sa+Sd+Sf+Sg−G1*(Sb+Sc+Se+Sh)
where Sa, Sb, Sc, Sd represent the outputs of the main light receiving parts, Se, Sf, Sg, Sh represent the outputs of the auxiliary light receiving part, and G1 represents a gain, and
when four light beams diffracted by four parts of the diffracting device are led to a tracking light receiving part,
the signal processor generates a tracking error signal according to following equation:
push-pull method=Si+Sj−(Sk+Sl)
where Sf and Se represent outputs of the third and fourth main light receiving parts.

19. The optical disk apparatus according to claim 10, which further comprises a diffracting device to diffract the laser beam reflected by the optical disk into each of the first to fourth main light receiving parts and the first to fourth auxiliary receive parts, and a tracking light receiving part for tracking, and wherein
the diffracting device includes two division parts divided by a dividing line in a disk radial direction and four division parts divided by a dividing curve reflecting±1st light diffracted from a land/groove disk,
when two light beams diffracted by two parts of the diffracting device is led to the main light receiving part and the auxiliary light receiving part, the focusing error signal is generated according to following equation:
double knife edge method=Sf+Sd+Sf+Sg−G1*(Sb+Sc+Se+Sh)
where Sb, Sc, Sd represent the outputs of the main light receiving parts, Sf, Sg, Sh represent the outputs of the auxiliary light receiving part, and G1 represents a gain, and
when four light beams diffracted by four parts of the diffracting device are led to the tracking light receiving part,
the tracking error signal is generated according to following equation:
DPD method=phase (Sf)−phase (Se)
where Sf and Se represent outputs of the third and fourth main light receiving parts.
